(19) United States
(12) Patent Application Publication
(10) Pub. No.: US 2024/0426061 A1
(43) Pub. Date: Dec. 26, 2024

(54) METHOD OF AND SYSTEM FOR FORMING A RECEPTACLE

(71) Applicant: Pulpex Limited, Sawston (GB)

(72) Inventors: Adam Richard TURNER, Sawston (GB); Daniel George PROZESKY, Sawston (GB); Theo Richard ASHCROFT, Sawston (GB)

(21) Appl. No.: 18/830,320

(22) Filed: Sep. 10, 2024

Related U.S. Application Data
(63) Continuation of application No. PCT/GB2023/050573, filed on Mar. 10, 2023.

(30) Foreign Application Priority Data
Mar. 11, 2022 (GB) 2203425.0

(51) Int. Cl. D21J 7/00

(52) U.S. Cl. CPC D21J 7/00

(57) ABSTRACT

There is disclosed a method of forming a moulded receptacle, comprising: applying a fibre suspension onto a mould cavity wall of a receptacle mould, the fibre suspension at least partially coating the mould cavity wall. The method further comprises supplying a fluid into direct contact with the fibre suspension on the mould cavity wall at a pressure of between about 3.5 bar and about 10 bar for a period of less than about 60 seconds, such that the fluid presses the fibre suspension against the mould cavity wall so that liquid is removed from the fibre suspension and passes through apertures formed in the mould cavity wall to form the moulded receptacle on the mould cavity wall.

### CROSS-REFERENCE TO RELATED APPLICATIONS

This application is a continuation under 35 U.S.C. § 120 of International Application No. PCT/GB2023/050573, filed Mar. 10, 2023, which claims priority to United Kingdom Application No. GB2203425.0, filed Mar. 11, 2022 under 35 U.S.C. § 119(a). Each of the above-referenced patent applications is incorporated by reference in its entirety.

### FIELD OF THE INVENTION

The present invention relates to a method and system of forming a moulded receptacle from a fibre suspension, such as comprising paper pulp. The receptacles may form consumer packaging, such as bottles, useful for holding liquids, powders, other flowable materials or solid objects.

### BACKGROUND

Bottles made from a fibre suspension are known and may be used in place of plastic bottles. These pulp-moulded bottles can therefore reduce the amount of plastic used in disposable consumer goods.

Published patent document WO2018/020219A1 describes forming a bottle from paper pulp in a mould. A fibre suspension is introduced into a mould and a layer is deposited on the inside of the mould. From here, a “bladder” is introduced into the mould and is inflated. The expansion of the bladder presses the fibre suspension against the mould to assist with forcing water out of the fibre suspension, resulting in a bottle being formed. This process of removing water is commonly known as “dewatering”. Further drying processes may then be performed to fully dry the bottle.

### SUMMARY

As mentioned, the use of inflatable bladders in forming pulp-moulded receptacles is known. However, these bladders can sometimes damage the delicate layer of pulp spread across the inside of the mould as the bladder is first introduced into the mould. Furthermore, these bladders have a finite lifetime, and are prone to breakage after repeated expansion and contraction, requiring frequent replacement. In addition, the material from which the bladders are made can have an uneven thickness and/or elasticity across the surface of the bladders as a result of manufacturing defects, which can result in the moulded bottles being unevenly compressed. Further still, the shapes of the bladders are restricted by the limited size of the opening via which they are inserted into the mould, and hence correspondingly the shapes of receptacles formed using a bladder are also constrained.

To mitigate the problems caused by the use of such bladders, the inventors have found that the bladders can be replaced by a high-pressure fluid that is applied directly onto the pulp. This high-pressure fluid may be air (such as compressed air), steam or superheated steam, for example. When the fluid is supplied into the mould, the force applied to the fibre suspension that coats the inside of the mould can be sufficient to give form to the receptacle and remove liquid from the fibre suspension), without needing to use a bladder.

As such, according to a first aspect of the present invention, there is provided a method of forming a moulded receptacle, the method comprising: (i) applying a fibre suspension onto a mould cavity wall of a receptacle mould, the fibre suspension at least partially coating the mould cavity wall, and (ii) supplying a fluid into direct contact with the fibre suspension on the mould cavity wall at a pressure of between about 3.5 bar and about 10 bar for a period of less than about 60 seconds, such that liquid is removed from the fibre suspension through apertures formed in the mould cavity wall to form the moulded receptacle on the mould cavity wall.

The inventors have found that pressures within this specific range applied for less than 60 seconds achieve the desired level of dewatering of the fibre suspension during this initial manufacturing procedure. For example, these pressures and times have been found to remove more than 5% of the liquid, such as more than 8%, or more than 10% of the liquid content. Reducing the water content by at least 5% can then reduce the time and/or energy required for further downstream drying processes. In one particular example, the pressure is between about 3.5 bar and about 9 bar.

In some examples, the flow rate of the fluid is selected to achieve adequate de-watering. In a particular example, supplying the fluid comprises supplying the fluid at a flow rate of greater than about 3 litres per minute (1/min). It has been found that a flow rate of greater than 31/min when the fluid is air provides the required amount of dewatering while avoiding damage to the receptacle.

In some examples, the flow rate of the fluid can be controlled or adjusted. In some examples, the flow rate is adjusted while the fluid is being supplied into the mould, but in other examples, the flow rate is constant while the fluid is being supplied (but may be adjusted before supplying the fluid). For example, a fluid supply system which supplies the fluid into the mould may comprise a flow rate device that allows the fluid flow rate to be adjusted. The flow rate device may comprise one or more apertures through which the fluid flows, and to control the flow rate, a certain number of apertures may be blocked off or closed to stop fluid from passing through those apertures. Additionally or alternatively, the size of one or more apertures may be adjusted/controlled by at least partially blocking those apertures to adjust the flow rate. Accordingly, in some examples, the method further comprises adjusting the flow rate of the fluid into the receptacle mould.

In certain examples, the method comprises supplying the fluid at a temperature of between about 10° C. and about 180° C. A temperature within this particular range may help control how much liquid is being removed from the fibre suspension.

In one example, supplying the fluid comprises supplying the fluid at a pulsed/variable pressure over time. The pressure may therefore periodically vary (or alternate) between a maximum pressure and a minimum pressure over time. The pressure profile over time may take the form of a square wave, a sinusoidal wave, a half-wave rectified sine, a full wave rectified sine or a triangular wave, etc. In other examples, the pressure may remain relatively constant over time, and therefore have a continuous profile over time. In either case, the pressure may also be ramped up when it is first applied (as will be discussed below).

The fibre suspension may have a first percentage liquid content by weight, L₁, when at least partially coating the mould cavity wall, and the moulded receptacle may have a second percentage liquid content by weight, L₂ (i.e., after the application of the fluid). Preferably, the pressure and timings are selected such that a percentage liquid content reduction, R, is greater than about 5%, where R=(L₁−L₂)/L₁. In a particular example, the first percentage liquid content by weight, L₁, is between about 80% and about 90%. In an example, the second percentage liquid content by weight, L₂, is between about 60% and about 80%. More particularly, the first percentage liquid content by weight, L₁, is between about 80% and about 83%, such as about 82%. In an example, the second percentage liquid content by weight, L₂, is between about 60% and about 70%, such as between about 71% and about 74%, such as about 72% or 73%. In an example, L₁=82%, L₂=73%, and R=11%.

In a particular configuration, the fluid may be air (such as compressed air) and the pressure may be between about 5 bar and about 10 bar, such as between about 7 bar and about 9 bar. In a particular example, the pressure is about 8 bar.

In certain examples, the receptacle may be known as a moulded receptacle, an article, a bottle, a container, a receptacle for containing fluid (such as a liquid) or solids (such as pharmaceutical or other tablets/capsules), an article for containing fluid, a bottle for containing fluid, a container for containing fluid, etc. The receptacle may be moulded from a fibre suspension, including constituents such as paper pulp. A fibre suspension may contain, amongst other things, cellulose fibres and a liquid, such as water. Additives may be present in the fibre suspension.

The receptacle may have a longitudinal axis along its length. The length/height of the receptacle may be greater than a width and/or depth of the receptacle. In some examples, the receptacle may have a generally circular footprint owing to a generally cylindrical form of the receptacle (at least along a portion of its length). In some examples, the receptacle may have a footprint that is square or squircular.

The receptacle mould (also referred to as a mould) defines a cavity (also known as a “mould cavity”) therein, and a layer or coating of the fibre suspension can be applied to the inner wall of the mould (the “mould cavity wall”). This initial layer/coating may have a first thickness, and after the fluid has been supplied, the receptacle may have a second thickness that is less than the first thickness owing to the compaction of the fibres and removal of some of the liquid. Applying the fibre suspension onto the mould cavity wall therefore comprises introducing the fibre suspension into a cavity of the mould.

In certain examples, the mould has an opening into the cavity, through which the fibre suspension may be supplied. In some examples, the cavity has a main body portion (also known as a first portion) and a neck portion (also known as a second portion). Both portions of the cavity together form the cavity. The neck portion may be used to form the neck of the receptacle/bottle. A lid/cap may be applied to an end of the neck of the receptacle, for example. In examples where the receptacle is to store/contain liquid, another fluid or a powder, the main body portion may contain the majority of the contents of the receptacle when in use. In some examples, the main body portion has a cross-sectional width that is larger than the cross-sectional width of the neck portion (the cross-section being taken in a plane parallel to a longitudinal axis of the receptacle).

In some examples, the mould is part of a split-mould, the split-mould being made of two or more moulds. For example, the mould may form half (or a third, or a quarter, etc.) of a split-mould and be brought together with at least one other mould before receiving the fibre suspension therein. The cavity of the mould may therefore only form a portion of the overall cavity of the split-mould and the mould cavity wall may therefore be used to form only part of an outer surface of the moulded receptacle. In some examples, the moulds forming the split-mould may be identical, but in other examples they may differ.

As mentioned, the cavity has apertures formed on/through the mould cavity wall. This allows liquid to pass from within the cavity to outside of the mould (and may be collected by a liquid measurement system, as will be explained below). The apertures may therefore extend from the cavity to an outer surface of the mould. In a particular example, the mould cavity wall of the receptacle mould has a smooth surface, and the apertures extend from the smooth surface. Applying the fibre suspension onto the mould cavity wall therefore comprises applying the fibre suspension to form a coating on the surface. In some examples, the mould/mould cavity is free from a mesh or net. This means that the moulded receptacle can be released from the mould relatively easily and the receptacle moulded in the mould can have a smoother outer surface than it might otherwise do if a mesh or net were included in the mould.

In an example, the mould is formed via a 3D printing or other additive manufacturing technique.

As mentioned, in some examples, the fluid that is supplied into direct contact with the fibre suspension spread across the inner wall of the cavity, is air. The use of air instead of steam, for example, may be less hazardous and have lower energy requirements (because the air does not necessarily need heating to the same degree). In other examples, the fluid is steam or superheated steam. The use of steam can provide additional heating and drying effects and thereby reduce the overall time taken to produce the receptacle. For example, when using steam, the receptacle may be heated by warm air during one or more further drying processes for a time period that is less than when the fluid is air.

In a particular example, the receptacle has a width (such as a diameter) of between about 65 mm and 70 mm, a height of between about 190 mm and about 200 mm, and a volume of between about 500 ml and 600 ml. In a further example, the receptacle has a diameter of about 68 mm, a height of about 196 mm and a volume of about 550 ml.

In some examples, the period for which the pressure is applied is less than about 35 seconds. In a particular configuration, the period for which the pressure is applied is between about 25 seconds and about 35 seconds. The inventors have found that pressures within the specific range noted above applied for this period is sufficient to remove the required amount of liquid from the fibre suspension, while also providing a good balance between energy costs and manufacturing efficiency. In some examples, the period is about 30 seconds. In some examples, the period is dependent on the pressure. In an example, the inventors found when L₁=82%, compressed air (applied at a pressure of about 4 bar) for a period of about 30 seconds formed a moulded receptacle having L₂=73%. In such an example, the receptacle may have the width, height and volume dimensions mentioned above.

In some examples, the length of time that the fluid (such as air or steam) is applied is controlled depending on the amount of liquid/water removed from the mould/fibre suspension (i.e., via the apertures in the cavity). As an example, the weight or volume of liquid that has been removed while applying the fluid can be measured, and the supply of fluid can be stopped when the desired amount has been measured.

In other examples, other factors are used to control the supply of fluid. For example, the fluid may be stopped after a predetermined period of time has elapsed. In another example, the volume/amount of fluid supplied to the mould may be measured (which may be inferred from measuring the remaining volume left in a storage tank, for example), and when the volume reaches a predetermined amount/volume, the fluid may be stopped. In another example, the temperature of the fluid could be measured, and when the measured temperature of the fluid has reached a predetermined temperature, the fluid supply may be stopped. The temperature may be the temperature of the fluid inside the mould, inside a storage tank of the fluid, between the storage tank and the mould, or extracted from the mould via the apertures or other opening, for example. In a further example, the pressure of the fluid may be measured over time, and when the pressure has dropped/reduced by a predetermined amount, the supply of fluid may be stopped. The pressure(s) may be the pressure(s) of the fluid inside the mould, inside a storage tank of the fluid, between the storage tank and the mould, or extracted from the mould via the apertures or other opening, for example. Accordingly, in some examples, the method comprises at least one of: (i) measuring a weight or volume of the liquid removed from the fibre suspension, and when the weight or volume of the liquid has reached a predetermined amount, stopping the supply of fluid, (ii) stopping the supply of fluid after a predetermined period of time, (iii) measuring a volume of fluid supplied into the mould, and when the measured volume of fluid has reached a predetermined amount, stopping the supply of fluid, (iv) measuring a temperature of the fluid, and when the measured temperature of the fluid has reached a predetermined temperature, stopping the supply of fluid, and (v) measuring a pressure reduction of the fluid, and when the pressure reduction has reached a predetermined amount, stopping the supply of fluid.

In some examples, a vacuum can be applied to the mould while the fibre suspension is being poured/drawn/inserted/introduced into the mould cavity. The vacuum can draw liquid through the apertures in the cavity wall and help coat the wall with the fibre suspension (forming a loose/wet version of the receptacle). In certain examples, it may be useful to stop applying the vacuum when the fluid (air, steam) is applied to provide a smoother exterior finish on the moulded receptacle and improve the energy efficiency (since applying a vacuum can be energy demanding). In some configurations, stopping the application of the vacuum may avoid the fluid interacting with the vacuum. Accordingly, the method may further comprise at least one of: (i) applying a vacuum to the receptacle mould while applying the fibre suspension onto the mould cavity wall and ceasing the applying the vacuum before the supplying the fluid, and (ii) ceasing the applying the vacuum after a predetermined period of time.

As mentioned above, it may be useful to measure the weight or volume of liquid that has been removed from the mould/fibre suspension. This may also be done while applying the vacuum during the application of the fibre suspension into the cavity. When the required amount of liquid has been measured, the vacuum can be switched off and the fluid then applied. By measuring the weight or volume of liquid removed from the mould, there is provided a consistent method of determining when to move to the next phase of the moulded receptable forming process. This may also improve uniformity between different receptacles. Accordingly, the method may further comprise: (i) measuring a weight or volume of liquid extracted from the receptacle mould while applying the vacuum, and (ii) when the weight or volume of liquid extracted from the receptacle mould has reached a predetermined amount, ceasing to apply the vacuum.

In certain circumstances, however, it may be nevertheless useful to also apply the vacuum while supplying the fluid to form the receptacle. Applying a vacuum during this process may help remove additional liquid from the moulded receptacle, thereby reducing the production time. Accordingly, the method may comprise applying a vacuum to the receptacle mould while applying the fibre suspension onto the mould cavity wall and while supplying the fluid.

The inventors have found that the amount of liquid removed from the fibre suspension/receptacle plateaus with increasing pressure as a result of the fluid (air/steam) escaping out of the mould. Excess pressure may therefore be superfluous. To determine the optimal pressure, it may be useful to perform a pressure determination process during which fluids at different pressures are applied to the mould and the pressure inside the receptacle/cavity is measured to determine a maximum pressure maintained within the receptacle. As an example, a pressure of 4 bar may be maintained inside the receptacle despite the fluid delivery pressure being 8 bar. It may therefore be desirable to use a pressure of about 4 bar (or just above 4 bar, such as 5 bar) during the formation of subsequent receptacles to improve efficiency and reduce production costs. Accordingly, in the above methods, the pressure may be less than about 1 bar above a maximum pressure determined to have been maintained within a previously moulded receptacle when supplying a fluid into the receptacle mould to press a fibre suspension against the mould cavity wall during a previous performance of the method. In certain examples, the method may comprise: determining a maximum pressure maintained within a previously moulded receptacle when supplying a fluid into the receptacle mould to press a fibre suspension against the mould cavity wall, and wherein the pressure is less than about 1 bar above the maximum pressure. This process ensures that the pressure being used is high enough to remove the required amount of liquid, without being excessively high.

As mentioned, after the receptacle has been formed in the mould, one or more additional drying/heating processes may occur. In one example, the receptacle is moved to a second, heated, mould, which aids the evaporation of further liquid from the receptacle. In another example, the receptacle is removed from the mould and is subjected to warm air. Accordingly, the method may further comprise applying heat to the moulded receptacle to remove liquid from the moulded receptacle.

In certain implementations, the fluid pressure is ramped up to a required pressure. For example, fluid at a low pressure is initially applied, and this is gradually increased over a certain time period, such as about 5 seconds. This avoids or reduces rupturing/damaging the layer of fibre suspension inside the cavity by suddenly supplying a fluid at a relatively high pressure to the fibre suspension. Accordingly, the pressure may be a final pressure, and supplying the fluid may comprise: (i) supplying the fluid at an initial pressure, and (ii) increasing the pressure from the initial pressure to the final pressure over a particular time period. The time period may, for example, be about 0.5 seconds, 1 second, 2 seconds, 3 seconds, 4 seconds, 5 seconds, etc. In one particular example, the time period is between about 0.5 seconds and about 5 seconds.

In some examples, the pressure that the fluid is applied at is selected based on one or more factors, such as the dimensions/volume of the receptacle. A lookup table or other database may store different pressures associated with different receptacle types or other criteria, and when the manufacturing process is begun, the correct pressure is selected based on the receptacle type that is being moulded. The receptacle type may be defined based on one or more parameters, such as the receptacle's dimensions and/or volume, and/or the composition of the fibre suspension, amongst other things. Accordingly, in some examples, the pressure is a particular pressure, and the method comprises determining the particular pressure on the basis of the receptacle type being moulded and/or one or more other criteria, and the supplying the fluid comprises supplying the fluid at the particular pressure. In some examples, the particular pressure is determined before supplying the fluid.

According to a second aspect of the present invention, there is provided a moulded receptacle produced by a method according to any of the methods described in the first aspect.

According to a third aspect of the present invention, there is provided a system for forming a moulded receptacle, the system comprising: (i) a receptacle mould having a mould cavity wall, the mould cavity wall being configured to receive a coating of a fibre suspension thereon and having apertures formed therein, (ii) a fibre suspension application system configured to apply the fibre suspension onto the mould cavity wall to at least partially coat the mould cavity wall, and (iii) a fluid supply system configured to supply a fluid into direct contact with the fibre suspension on the mould cavity wall at a pressure of between about 3.5 bar and about 10 bar for a period of less than about 60 seconds, such that liquid is removed from the fibre suspension through the apertures to form the moulded receptacle on the mould cavity wall.

In certain examples, the fluid supply system is configured to supply the fluid at a pulsed pressure over time.

In a particular example, the fluid supply system is configured to supply the fluid at a flow rate of greater than about 3 litres per minute. In some examples, the fluid supply system is configured to control the flow rate of the fluid into the receptacle mould.

In some examples, the system further comprises at least one of: (i) a liquid measurement system configured to measure a weight or volume of the liquid removed from the fibre suspension, wherein the fluid supply system is configured to stop the supply of the fluid when the liquid measurement system determines that the weight or volume of the liquid has reached a predetermined amount, (ii) a timing system configured to measure a time during which the fluid supply system supplies the fluid, wherein the fluid supply system is configured to stop the supply of the fluid when the timing system determines that time has reached a predetermined period of time, (iii) a fluid measurement system configured to measure a volume of fluid supplied by the fluid supply system, wherein the fluid supply system is configured to stop the supply of the fluid when the fluid measurement system determines that the volume of fluid has reached a predetermined amount, (iv) a temperature measurement system configured to measure a temperature of the fluid, wherein the fluid supply system is configured to stop the supply of the fluid when the temperature measurement system determines that the temperature of the fluid has reached a predetermined temperature, and (v) a pressure measurement system configured to measure a pressure reduction of the fluid, wherein the fluid supply system is configured to stop the supply of the fluid when the pressure measurement system determines that the pressure reduction of the fluid has reached a predetermined amount.

In some examples, the system further comprises: a vacuum application system configured to: (i) apply a vacuum to the receptacle mould while the fibre suspension application system applies the fibre suspension onto the mould cavity wall, and (ii) stop applying the vacuum before the fluid supply system supplies the fluid.

In some examples, the system further comprises at least one of: (i) a liquid measurement system configured to measure a weight or volume of the liquid removed from the receptacle mould while the vacuum is applied and wherein the vacuum application system is configured to stop applying the vacuum when the liquid measurement system determines that the weight or volume of the liquid has reached a predetermined amount, and (ii) a timing system configured to measure a time during which the vacuum application system applies the vacuum, wherein the vacuum application system is configured to stop the application of the vacuum when the timing system determines that time has reached a predetermined period of time.

In some examples, the system further comprises: a vacuum application system configured to: apply a vacuum to the receptacle mould while the fibre suspension application system applies the fibre suspension onto the mould cavity wall and while the fluid supply system supplies the fluid.

In some examples, the fluid supply system is configured to supply the fluid at a pressure less than about 1 bar above a maximum pressure determined to have been maintained within a previously moulded receptacle when the fluid supply system supplied a fluid into the receptacle mould to press a fibre suspension against the mould cavity wall during formation of the previously moulded receptacle. Thus, in some examples, the system further comprises a pressure measurement device configured to: determine a maximum pressure maintained inside the previously moulded receptacle while the fluid supply system supplies fluid into the previously moulded receptacle at a range of different pressures.

In certain examples, the pressure is a final pressure, and the fluid supply system is configured to: (i) supply the fluid at an initial pressure, and (ii) increase the pressure from the initial pressure to the final pressure over a particular time period.

In some examples, the fluid supply system is configured to: (i) determine a particular pressure on the basis of the receptacle type being moulded and/or one or more other criteria, and (ii) supply the fluid at the particular pressure.

In some arrangements, it may be useful to vent the cavity of the mould from high pressure to atmospheric pressure to rapidly reduce the internal pressure and hasten the process. Thus, in some examples, the receptacle mould comprises a cavity (or “mould cavity”) and an opening through which the fluid can escape from the cavity while the fluid supply system supplies the fluid. The mould cavity wall is therefore a wall of the mould cavity.

According to a fourth aspect of the present invention, there is provided a method of forming a moulded receptacle, the method comprising: applying a fibre suspension onto a mould cavity wall of a receptacle mould, the fibre suspension at least partially coating the mould cavity wall; and supplying a fluid into direct contact with the fibre suspension on the mould cavity wall at a particular pressure, such that the fluid presses the fibre suspension against the mould cavity wall to assist with removing liquid from the fibre suspension by encouraging it to pass through apertures formed in the mould cavity wall to form the moulded receptacle on the mould cavity wall. The pressure may be less than about 1 bar above a maximum pressure determined to have been maintained within a previously moulded receptacle when supplying a fluid into the receptacle mould to press a fibre suspension against the mould cavity wall during a previous performance of the method. The fourth aspect may additionally include any of the methods or features described above in relation to the first aspect.

According to a fifth aspect of the present invention, there is provided a system for forming a moulded receptacle, comprising: a receptacle mould having a mould cavity wall, the mould cavity wall being configured to receive a coating of a fibre suspension thereon and having apertures formed therein; a fibre suspension application system configured to apply the fibre suspension onto the mould cavity wall to at least partially coat the mould cavity wall; and a fluid supply system configured to supply a fluid into direct contact with the fibre suspension on the mould cavity wall at a particular pressure, such that the fluid presses the fibre suspension against the mould cavity wall to assist with removing liquid from the fibre suspension and encouraging it to pass through the apertures formed in the mould cavity wall to form the moulded receptacle on the mould cavity wall. The fluid supply system may be configured to supply the fluid at a pressure less than about 1 bar above a maximum pressure determined to have been maintained within a previously moulded receptacle when the fluid supply system supplied a fluid into the receptacle mould to press a fibre suspension against the mould cavity wall during formation of the previously moulded receptacle. The fifth aspect may additionally include any of the features described above in relation to the third aspect.

Further features and advantages of the invention will become apparent from the following description of preferred embodiments of the invention, given by way of example only, which is made with reference to the accompanying drawings.

### BRIEF DESCRIPTION OF THE DRAWINGS

Embodiments of the invention will now be described, by way of example only, with reference to the accompanying drawings, in which:

FIG. 1 shows an example of a process for producing a receptacle at least partially moulded from a fibre suspension;

FIG. 2 shows an example receptacle mould;

FIG. 3 shows an example receptacle moulded in the receptacle mould of FIG. 2;

FIG. 4A shows a cross-section of an example mould before a fibre suspension is introduced into the mould cavity;

FIG. 4B shows a cross-section of the example mould after a fibre suspension has been applied to the inner wall of the cavity;

FIG. 4C shows a cross-section of the example mould after the fibre suspension has been urged against the inner wall of the cavity by a pressurised fluid;

FIGS. 5A and 5B show example systems for forming a moulded receptacle;

FIG. 6A shows a graph of a variable fluid pressure, according to a first example;

FIG. 6B shows a graph of a variable fluid pressure, according to a second example; and

FIG. 7 shows an example flow diagram of a method for forming a moulded receptacle.

### DETAILED DESCRIPTION

The following description presents exemplary embodiments and, together with the drawings, serves to explain principles of the invention.

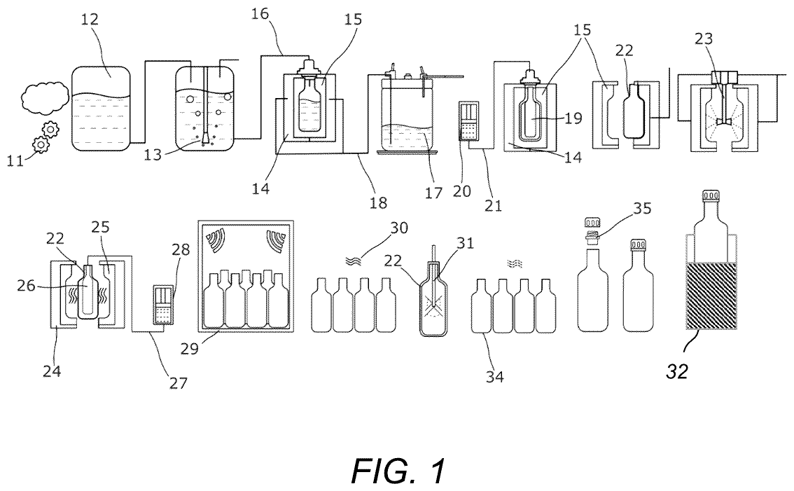

FIG. 1 shows a process for making bottles from paper pulp (i.e., which can form the basis of an example fibre suspension). The process is merely exemplary and is provided to give context to examples of the present invention. Broadly speaking, the exemplary process comprises providing a fibre suspension, introducing the fibre suspension into a porous first mould and using the porous first mould to expel a liquid (such as water) from the fibre suspension to produce a wet precursor (which may be considered a moulded receptacle), further moulding the wet precursor in a mould to produce a further-moulded receptacle/article, coating interior and exterior surfaces of the further-moulded receptacle to produce a coated moulded receptacle, drying the coated moulded receptacle to produce a dried receptacle/article, and applying a closure to the dried receptacle. As will be apparent from the following description, modifications may be made to the exemplary process to provide variants thereof in which other examples of the present invention may be embodied.

In this example, providing the fibre suspension comprises preparing the fibre suspension from ingredients thereof. More specifically, the preparing comprises providing pulp fibres, such as paper pulp fibres, and mixing the pulp fibres with a liquid to provide hydrated pulp fibres. In this example, the pulp fibres are provided in sheet form from a supplier and the liquid comprises water and one or more additives. The hydrated pulp fibres are passed between plates of a valley beater 11 or refiner that are in motion relative to each other. This fibrillates some or all of the fibres, meaning that cell walls of those fibres are caused to become partially delaminated so that wetted surfaces of those fibres comprise protruding hairs or fibrillations. These fibrillations will help to increase a strength of bonds between the fibres in the dried end product. In other examples, the valley beater or refiner may be omitted. The resultant processed pulp is stored in a vat 12 in a relatively concentrated form to reduce a required storage space. At an appropriate time, the processed pulp is transferred to a mixing station 13 at which the processed pulp is diluted in further water to provide the fibre suspension ready for moulding. In this example, the solid fibres account for 0.7% wt of the resultant fibre suspension, but in other examples the proportion of solid fibres in the fibre suspension may be different, such as another value in the range of 0.5 wt % to 5% wt of the fibre suspension. Mixing of the fibre suspension at the mixing station 13 helps to homogenise the fibre suspension. In other examples, the processed pulp or the fibre suspension may be provided in other ways, such as being supplied ready-made.

The porous first mould 15 comprises two half-moulds that are movable towards and away from each other using a hydraulic ram. In this example, each of the half-moulds is a monolithic or unitary 3D-printed tool that defines a mould profile, and when the half-moulds are brought into contact with each other their respective mould profiles cooperate to define a moulding cavity. Each half-mould may itself define a smaller cavity and when brought into cooperation with a second half-mould, a larger moulding cavity is provided. The two half-moulds may themselves be considered “moulds” and the overall porous first mould 15 may be considered a “split-mould” or again a “mould”.

In FIG. 1, the fibre suspension (also known as slurry) is top-filled into the porous mould 15, by contrast to moulding processes that dip a mould in slurry. The fibre suspension is thereafter drawn via line 16 under a vacuum through the porous mould 15, similar to an injection moulding machine. Shot mass may be controlled by measuring (e.g., weighing) the mass/volume of water being drawn into the tank 17. Once the required mass is reached, the porous mould 15 is opened to ambient air. A weight scale platform supporting tank 17 is visible in FIG. 1.

The suspending liquid drawn with the fibre suspension in line 16 is water, or predominantly water (as additives may also be present). This liquid drawn under vacuum through the line 18 and into the tank 17 is substantially free of fibres since these are left behind against the walls of the porous mould 15. By way of example, suction of the suspending liquid 18 through the porous mould 15 is continuous until a predetermined volume (e.g., 10 litres) of water has been collected in the tank 17.

The “receptacle” within the porous mould 15 is, at this stage, a wet form or shape held against the internal walls of the mould.

In prior art processes, in order to remove further suspending liquid (water) and form/consolidate the 3D receptacle shape, an impermeable inflation element, e.g., a collapsible bladder 19, is inserted into the porous mould 15 to act as an internal high-pressure core structure for the mould. As mentioned, this process strengthens the wet ‘embryo’ bottle so that it can be handled (or transported by mechanised means) before drying and displaces water in-between the fibres, thereby increasing the efficiency of the drying process. The bladder 19 is actuated/regulated using a hydraulic pump 20 with a cylinder that displaces a fluid in line 21 into bladder 19 to expand the bladder 19 radially and to conform to the mould cavity. Fluid within the line 21 is preferably non-compressible, such as water. Water also has the advantage over other non-compressible liquids that any leaking or bursting of the bladder 19 will not introduce a new substance to the system (since the suspending liquid is already water or predominantly water).

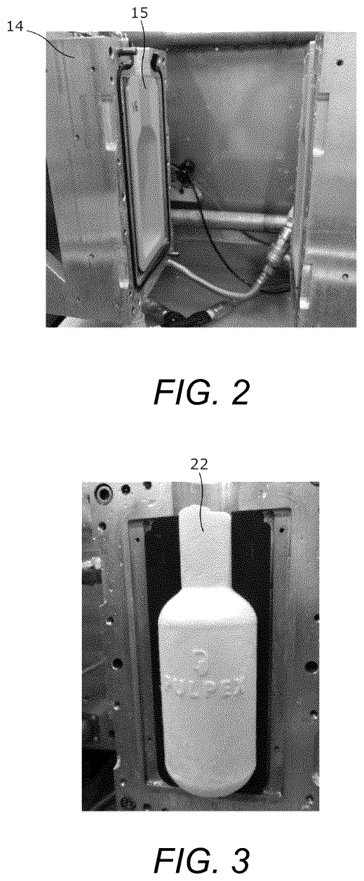

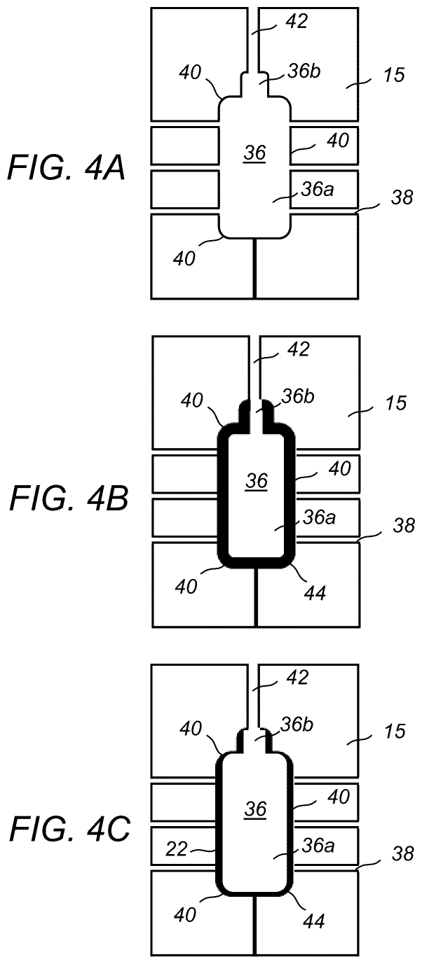

FIGS. 2 and 3 show, pictorially, the appearance of a two-part block 14 that houses the porous mould 15 (the non-porous mould 25 described below would have a similar appearance). Channels through the block 14 communicate with the porous mould 15 to provide a path for suspending liquid drawn through the porous mould 15, and also reverse flow during mould cleaning (described below).

Demoulding occurs when the porous mould 15 opens for removal of a self-supporting (and therefore “formed”) receptacle 22. Mould cleaning 23 is preferably performed subsequently, to remove small fibres and maintain a porosity of the porous mould 15. In the illustrated form, a radially firing high-pressure jet is inserted into the mould cavity while the mould is open. This dislodges fibres from the wall of the cavity. Alternatively, or in addition, water from the tank 17 is pressurised through the back of the porous mould 15 to dislodge entrapped fibres. Water is drained for recycling back to an upstream part of the system. It is noteworthy that cleaning is important for conditioning the tool for re-use. The tool may appear visibly clean after removal of the receptacle, but its performance could be compromised without cleaning.

According to FIG. 1, the formed but unfinished receptacle 22 is subsequently transported to a second or further moulding station where, in a, e.g., aluminium, tool/mould 25, pressure and/or heat is applied for thermoforming a desired neck and surface finish. After the two halves of the mould 25 (optionally including negative surface features for debossing/embossing, etc.) have closed around the receptacle 22, a pressuriser is engaged. For example, a bladder 26 (e.g., a thermoforming bladder 26) is inserted into the receptacle 22. The bladder 26 is inflated via a line 27 by a pump 28 with a heater to supply pressurised fluid, e.g., air, water or oil. An external mould block 24 of the mould 25, and/or the mould 25 itself, may also, or alternatively, be heated.

The state of the moulded receptacle 22, after thermoforming, is considerably more rigid, with more compressed side walls, compared with the state at demoulding from the porous mould 15.

A drying stage 29 (microwave or otherwise) can be applied downstream of thermoforming, as shown. However, moulding in the mould 25 requires some water content in order to assist with bonding during the compression process. In some forms, microwave or other drying options may be applied at multiple stages of the process. In one example, the drying stage 29 is performed before thermoforming.

FIG. 1 illustrates a further drying stage 30, that may utilise hot air circulated onto the bottles, e.g., in a “hot box”, prior to a coating stage where, for example, a spray lance 31 inserted into the bottle 22 applies a surface coating to internal walls of the bottle 22. In another example, the receptacle 22 may be filled with a liquid that coats the inner surface of the receptacle 22. In practice, the coating provides a protective layer to prevent egress of liquid contents into the bottle wall which may permeate and/or weaken it. Coatings will be selected dependent on the intended contents of bottle 22, e.g., a beverage, detergent, pharmaceutical product, etc. In some examples, the further drying stage 30 is performed after the coating stage (or both before and after the coating stage).

A subsequent curing process 34 can be optimised dependent on the coating, e.g., drying for twenty-four hours at ambient conditions or by a flash drying method. In examples where the further drying stage occurs after the coating stage, the curing process 34 may be omitted.

At an appropriate stage of production (e.g., during thermoforming, before or after coating) a closure or mouth forming process may be performed on the receptacle. The receptacle 22 may therefore be fully formed and be ready to accept contents therein.

In some examples, an exterior coating is applied to the receptacle, as showed in the further coating stage 32. In one example, the receptacle 22 is dipped into a liquid that coats the outer surface of the receptacle as shown in FIG. 1. One or more further drying or curing processes may then be performed. For example, the receptacle may be allowed to dry in warm air.

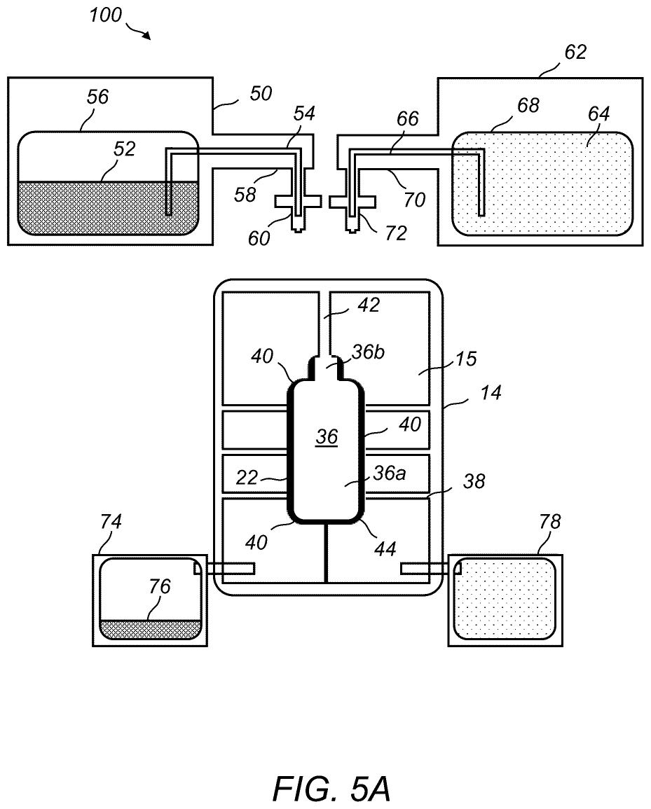

FIGS. 4A-4C illustrate schematic examples of a porous mould 15 at different times during the moulding process. FIG. 4A depicts the mould 15 before the fibre suspension has been introduced into the mould 15, FIG. 4B depicts the mould 15 after the fibre suspension has been introduced into the mould 15, and FIG. 4C depicts the mould 15 after a high-pressure fluid has been suppled into the mould 15 to directly contact the fibre suspension thereby to compress the fibre suspension against the cavity wall of the mould 15.

In more detail, FIG. 4A depicts a mould 15 formed from two separate half-moulds. Each half-mould may itself be referred to as a mould in certain examples, and each half-mould may define a cavity having a mould cavity wall onto which the fibre suspension is applied. When the two half-moulds are brought together, the two cavities form a larger cavity 36 in the mould 15. In other examples, the mould 15 may be made of a single piece.

FIG. 4A depicts apertures 38 in/through the mould cavity wall 40. As mentioned earlier, these apertures 38 allow liquid to pass through. In FIG. 4A, the cavity 36 is “empty” since the fibre suspension has not yet been supplied to the mould 15. The mould 15 is formed such that there is an opening 42 into the cavity 36.

As shown in FIG. 4A, the mould cavity wall 40 (i.e., the inner wall of the cavity 36) has a surface and the apertures 38 extend from the surface and through the mould 15 to an outer surface of the mould. In certain examples, the cavity is free from a net or mesh, and therefore has a generally smooth surface from which the apertures 38 extend.

In the example of FIG. 4A, the cavity 36 (and also each cavity of the half-moulds) has a main body portion 36a (also known as a first portion) and a neck portion 36b (also known as a second portion). The neck portion 36b may be used to form the neck of the receptacle/bottle.

FIG. 4B depicts the mould 15 at a later time. Here, the fibre suspension has been poured/drawn into the cavity 36 via the cavity opening 42 (in some cases under vacuum) and the fibre suspension coats the mould cavity wall 40 to form a loose receptacle shape. Liquid may be extracted or drained through the apertures 38. At this point, the fibre suspension coating/layer 44 has an initial thickness on the cavity wall 40 and the fibre suspension layer 44 has a percentage liquid content by weight, L₁, which may be between about 80% and about 90%.

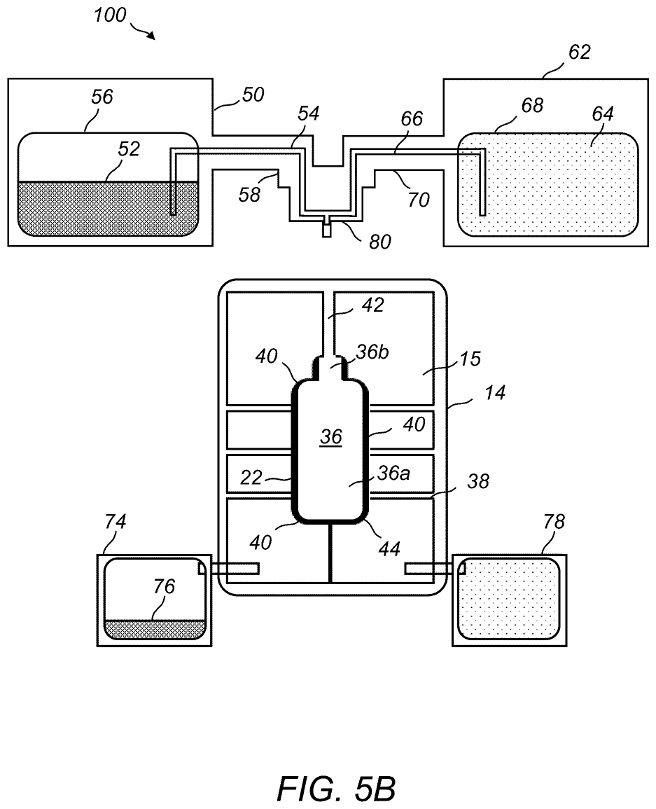

In contrast to the example process described above in relation to FIG. 1 where a bladder 19 is used, the following example forgoes the bladder 19, and instead uses a high-pressure fluid to assist with de-watering the receptacle 22 within the mould 15. Accordingly, after the fibre suspension has been applied to the mould cavity wall 40, a fluid supply system (shown in FIGS. 5A and 5B) supplies a fluid (such as compressed air, steam or superheated steam) into direct contact with the fibre suspension layer 44 on the mould cavity wall 40 at a particular pressure and for a particular period/length of time. This high-pressure fluid presses/compacts the fibre suspension layer 44 and helps to drive out liquid. This liquid may then pass through the apertures 38, in some cases under vacuum.

FIG. 4C shows the receptacle 22 formed inside the cavity 36 of the mould 15 after the high-pressure fluid has been supplied. The high-pressure fluid has compacted the fibre suspension layer 44 and de-watered it, and the layer 44 is therefore thinner than depicted in FIG. 4B. At this point in time, the fibre suspension has a percentage liquid content by weight, L₂, which may be between about 60% and about 80%, depending on the fluid pressure and the length of time the fluid was supplied.

FIG. 5A depicts an example system 100 for forming a moulded receptacle 22.

The system 100 includes the receptacle mould 15 to receive the fibre suspension and a fibre suspension application system 50 to introduce/supply the fibre suspension 52 into the cavity 36 and onto the mould cavity wall 40.

In this example, the fibre suspension application system 50 includes a tank 56 which temporarily contains the fibre suspension 52 before it is introduced into the mould 15. The fibre suspension application system 50 may be used along with the mixing station 13 of FIG. 1, or the mixing capabilities of the mixing station 13 may be performed by the fibre suspension application system 50 itself. The fibre suspension application system 50 of this example also includes a line 54 along which the fibre suspension 52 can flow from the tank 56 and into the mould 15. The line 54 may be flexible in some examples.

The fibre suspension application system 50 of this particular example also includes an arm 58 and a connecting portion 60. The line 54 runs through the arm 58 and into the connecting portion 60. The fibre suspension 52 exits the fibre suspension application system 50 and enters the mould 15 via the connecting portion 60 and the opening 42. In some examples, the connecting portion 60 is shaped to cooperate with the top of the mould 15 and/or the block 14 which contains the mould. In a particular example, the arm 58 is static, and the mould 15 is moved into place under the connecting portion 60. In another example, the arm 58 can be moved (by a human operator, or another piece of machinery) so that the connecting portion 60 can be connected to the mould 15. In a further example, the arm 58 is robotic (that is, it can move itself into the desired location).

The system 100 also includes a fluid supply system 62 to supply a fluid 64 (such as compressed air or steam) into direct contact with the fibre suspension (i.e., the fibre suspension layer 44) that at least partially coats the mould cavity wall 40. The pressure at which the fluid 64 can be applied can be controlled via a control system (not shown). In an example, the pressure is between about 3.5 bar and about 10 bar. Similarly, the time over which the fluid 64 can be applied can be controlled via the control system. In an example, the fluid is supplied for a period of less than about 60 seconds, such as about 30 seconds. The fluid passes into the cavity 36 and presses the fibre suspension 44 against the mould cavity wall 40 so that liquid is assisted with being removed from the fibre suspension and encouraged to pass through the apertures 38 formed in the mould cavity wall 40. After this process, a moulded receptacle 22 is formed on the mould cavity wall 40.

The fluid supply system 62 of this example also includes a line 66 along which the fluid 64 can flow from the tank 68 and into the mould 15. The line 66 may be flexible in some examples. In this example, the fluid supply system 62 also includes an arm 70 and a connecting portion 72. The line 66 runs through the arm 70 and into the connecting portion 72. The fluid 64 exits the fluid supply system 62 and enters the mould 15 via the connecting portion 72 and the opening 42. In some examples, the connecting portion 72 is shaped to cooperate with the top of the mould 15 and/or the block 14 which contains the mould. In a particular example, the arm 70 is static, and the mould 15 is moved into place under the connecting portion 72. In another example, the arm 70 can be moved (by a human operator, or another piece of machinery) so that the connecting portion 72 can be connected to the mould 15. In a further example, the arm 70 is robotic (that is, it can move itself into the desired location).

In some examples, depicted in FIG. 5B, lines 54 and 66 both run into a single connecting portion 80, such that two separate connecting portions 60, 72 are not needed. A single connecting portion 80 that supplies the fluid 64 and the fibre suspension 52 into the mould 15 may be preferred because the mould 15 and/or arms 58, 70 may not need to be moved. Other than the single connecting portion 80, the system of FIG. 5B operates in the same way as the system of FIG. 5A.

As discussed, the fluid supply system 62 supplies fluid 64 at a high pressure into the mould 15 to assisting with forcing out liquid in the fibre suspension 44 to de-water the receptacle 22. In certain examples, the fluid supply system 62 supplies fluid 64 during a moulding process at a variable pressure. For example, the pressure may ramp up from an initial, lower pressure, to a final, higher pressure. The control system may control the pressure ramping and the time each pressure within this pressure ramp is applied.

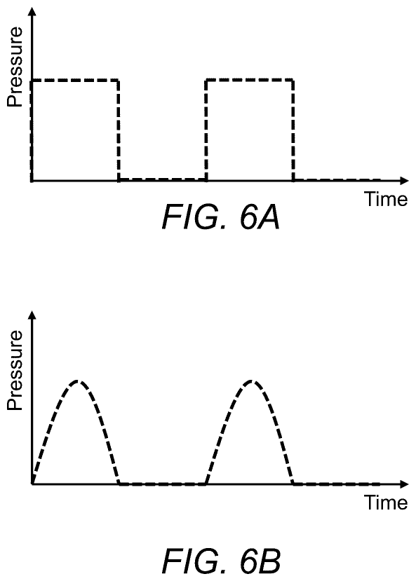

In some examples, the fluid pressure is additionally or alternatively pulsed over time (i.e., the pressure is periodically varied). FIG. 6A shows an example of the fluid pressure being pulsed according to a square-wave profile. Similarly, FIG. 6B shows the fluid pressure being pulsed according to a half-wave rectified sine profile. In some examples (not illustrated in FIG. 6A), each time the fluid pressure is increased to the maximum pressure, the pressure is gradually ramped up over a particular time period, as mentioned above. Although FIGS. 6A and 6B show the fluid pressure being pulsed at a constant frequency, in other examples, the frequency is non-constant over time. In another example (not shown) instead of having periods in which the pressure is constant over a particular period (as in FIGS. 6A and 6B), the pressure may be constantly changing over time. As an example, the pressure may be pulsed according to a sinusoidal wave.

In certain examples, the pressure (or pressures) of the fluid 64 that is supplied is dependent on the type of receptacle being moulded (or other criteria). For example, a receptacle with a thicker wall may require a higher-pressure fluid to sufficiently compact the pulp fibres. Accordingly, the control system may also supply the fluid 64 based on the type of receptacle currently being moulded. A human operator may, for example, provide a user input indicative of the receptacle type to the control system. Based on this input, the control system may select the appropriate pressure(s). In some examples, the control system may automatically detect the receptacle type based on data measured by one or more sensors, for example. Alternatively, the human operator may select the particular pressure(s) directly. Once a particular pressure has been determined, the fluid supply system 62 supplies fluid 64 at the determined pressure.

In some examples, it may be useful to allow some of the pressurised fluid 64 to escape from the mould 15 as it is being supplied by the fluid supply system 62. Venting the cavity 36 may be useful to rapidly reduce the internal pressure of the mould cavity 36 and decrease the time taken to form the receptacle 22. To achieve this, the cavity 36 may be opened to the atmosphere via a passage or opening, through which some of the pressurised fluid may escape. For example, the opening 42 to the cavity may be left at least partially open when the fluid supply system 62 supplies the fluid 64. In one example, the connecting portion 72, 80 has an aperture formed therethrough, so that the fluid 64 can escape from the cavity 36 via the opening 42.

In certain arrangements, the system 100 may further include a liquid measurement system 74 configured to measure a weight or volume of the liquid removed from the fibre suspension/mould 15. In one example, the liquid measurement system 74 may include the weight scale platform and tank 17 depicted in FIG. 1. In another example, the liquid measurement system 74 is different to that depicted in FIG. 1 and may be used in place of the weight scale platform and tank 17.

The liquid measurement system 74 may weigh or measure the volume of liquid extracted from the mould 15. For example, the liquid measurement system 74 may weigh or measure the volume of liquid 76 extracted from the mould 15 during the process of supplying the fibre suspension 52 into the mould 15 and/or during the process of applying a vacuum (discussed below) and/or during the process of supplying the fluid 64 into the mould 15. The liquid measurement system 74 may be communicatively coupled to the control system and/or other components of the system 100 so that actions can be stopped or performed or altered when the measured weight/volume reaches a particular threshold amount (or one or more different threshold amounts).

For example, the fluid supply system 62 may be controlled to cease/stop the supply of the fluid 64 when the liquid measurement system 74 determines that the weight or volume of the liquid 76 has reached a predetermined amount. The predetermined amount may be an amount removed from the mould 15 during the time the fluid is supplied, or may be an amount removed from the mould 15 during the entire moulding process up until that point in time (and so may include the liquid removed during the process of supplying the fibre suspension into the mould and/or applying a vacuum to the mould).

In certain examples, the system 100 further includes a vacuum application system 78 configured to apply a vacuum to the receptacle mould 15 (and/or the block 14). In one particular example, the vacuum is applied while the fibre suspension application system 50 supplies the fibre suspension 52 into the mould 15 (and possibly after the fibre suspension has been supplied), but the vacuum is no longer applied when the fluid supply system 62 supplies the fluid 64. The vacuum may be removed, in one example, when a required weight or volume of liquid 76 has been extracted from the mould 15. In that case, the liquid measurement system 74 may determine that the weight or volume of the liquid has reached a predetermined amount and the vacuum application system 78 ceases applying the vacuum when the weight or volume of the liquid has reached a predetermined amount (where the predetermined amount may be different to that used to control the application of the fluid 64). Data or an instruction may be sent from the liquid measurement system 74 to the vacuum application system 78 indicative of the volume or weight of liquid and/or when the volume or weight reaches the predetermined amount. The vacuum application system 78 may then operate depending on the data/instruction. Similarly, the fibre suspension application system 50 may also be controlled when the liquid measurement system 74 determines that the weight or volume of the liquid 76 has reached a predetermined amount.

In another example, the vacuum is applied while the fibre suspension application system 50 supplies the fibre suspension 52 into the mould 15, and while the fluid supply system 62 supplies the fluid 64.

In some examples, the system 100 further includes a timing system (not shown) configured to measure a time during which the fluid supply system 62 supplies the fluid 64. The timing system may be part of the fluid supply system, in certain examples. The fluid supply system 62 may be configured to stop the supply of the fluid 64 when the timing system determines that time has reached a predetermined period of time. For example, the timing system may control the fluid supply system 62 to stop the supply of fluid when the time reaches 30 seconds.

In certain examples, the system 100 further includes a fluid measurement system (not shown) configured to measure a volume of fluid 64 supplied by the fluid supply system 62. The fluid measurement system may be part of the fluid supply system 62, in certain examples. The fluid supply system 62 may be configured to stop the supply of the fluid 64 when the fluid measurement system determines that the volume of fluid has reached a predetermined amount. The volume of fluid 64 may be determined/inferred based on the volume of fluid contained in the tank 68, for example.

In some examples, the system 100 further includes a temperature measurement system (not shown) configured to measure a temperature of the fluid 64. The temperature may be a temperature of the fluid in the tank 68, at a point between the tank 68 and the connecting portion 72, 80, within the mould 15, or at an outlet of the mould (such as near an aperture 38). The fluid supply system 62 may be configured to stop the supply of the fluid 64 when the temperature measurement system determines that the temperature of the fluid has reached a predetermined temperature. For example, as fluid is supplied to the mould 15, the temperature of the fluid in the tank 68 may reduce, and when the temperature or temperature change reaches a predetermined temperature or temperature change, the fluid supply may be stopped.

In another example, the system 100 further includes a pressure measurement system (not shown) configured to measure a pressure reduction of the fluid 64. The pressure reduction may be a pressure reduction of the fluid in the tank 68, at a point between the tank 68 and the connecting portion 72, 80, within the mould 15, or at an outlet of the mould (such as near an aperture 38). The fluid supply system 62 may be configured to stop the supply of the fluid 64 when the pressure measurement system determines that the pressure reduction of the fluid has reached a predetermined amount. For example, as fluid is supplied to the mould 15, the pressure of the fluid in the tank 68 may reduce, and when the pressure change/reduction reaches a predetermined amount, the fluid supply may be stopped.

In a particular example, the fluid supply system 62 is configured to supply the fluid at a particular flow rate. Accordingly, the fluid supply system 62 may comprise a flow rate device that can adjust or control the flow rate based on particular requirements. The flow rate device might be located in the connecting portion 72, 80 or elsewhere within the fluid supply system 62. The flow rate device may comprise an aperture (or a plurality of apertures) through which the fluid flows, and the size of the aperture may be adjusted to adjust the flow rate (using a valve, for example). In examples where there are a plurality of apertures, one or more of the apertures may be blocked or closed to adjust the flow rate.

As discussed earlier, in some examples, the fluid supply system 62 may be configured to supply the fluid at a pressure less than about 1 bar above a maximum pressure determined to have been maintained within a previously moulded receptacle when the fluid supply system 62 supplied a fluid into the receptacle mould. Accordingly, in some examples, there is a pressure measurement device (not shown) that measures the fluid pressure inside the previously moulded receptacle during its moulding. During this pressure determination process, the fluid supply system 62 may apply fluid at different pressures (such as 4 bar, 5 bar, 6 bar, 7 bar, 8 bar, 9 bar, 10 bar, etc.) and the pressure inside the receptacle can be determined by the pressure measurement device. The inventors found that under certain conditions, despite the fluid pressure increasing, the pressure measured inside the cavity plateaus. This “plateau pressure” is an indication of the maximum pressure maintained inside the receptacle. Excess pressure can therefore leak out of the receptacle mould. Accordingly, when moulding subsequent receptacles, the fluid pressure supplied by the fluid supply system may be set at (or just above) this maximum pressure (assuming the same type of receptacles are being formed). In certain examples, it may be useful to set the fluid supply pressure at less than 1 bar above the maximum pressure for efficiency.

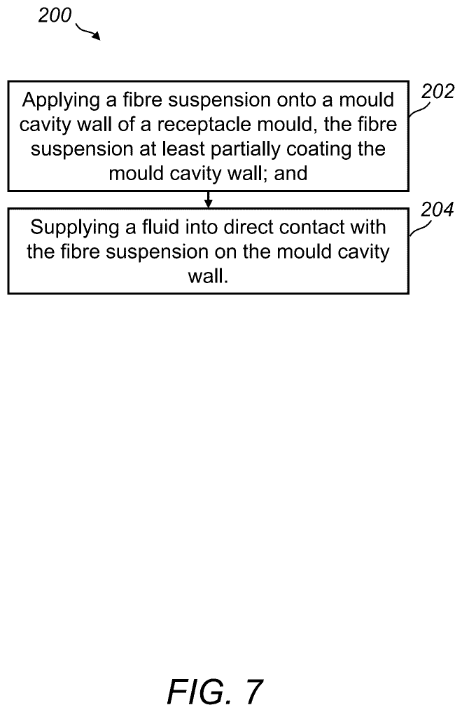

FIG. 7 depicts an example method 200 of forming a moulded receptacle. In a first block 202, the method comprises applying a fibre suspension onto a mould cavity wall of a receptacle mould, the fibre suspension at least partially coating the mould cavity wall. In a second block 204, the method further comprises supplying a fluid into direct contact with the fibre suspension on the mould cavity wall at a pressure of between about 3.5 bar and about 10 bar for a period of less than about 60 seconds. This high-pressure fluid presses the fibre suspension against the mould cavity wall so that liquid is encouraged to be removed from the fibre suspension and pass through apertures formed in the mould cavity wall to form the moulded receptacle on the mould cavity wall.

The above embodiments are to be understood as illustrative examples of the invention. Further embodiments of the invention are envisaged. It is to be understood that any feature described in relation to any one embodiment may be used alone, or in combination with other features described, and may also be used in combination with one or more features of any other of the embodiments, or any combination of any other of the embodiments. Furthermore, equivalents and modifications not described above may also be employed without departing from the scope of the invention, which is defined in the accompanying claims.

What is claimed is:

1. A method of forming a moulded receptacle, the method comprising:
applying a fibre suspension onto a mould cavity wall of a receptacle mould, the fibre suspension at least partially coating the mould cavity wall; and
supplying a fluid into direct contact with the fibre suspension on the mould cavity wall at a pressure of between about 3.5 bar and about 10 bar for a period of less than about 60 seconds, such that liquid is removed from the fibre suspension through apertures formed in the mould cavity wall to form the moulded receptacle on the mould cavity wall.

2. The method of claim 1, wherein the fluid is air or super-heated steam.

3. The method of claim 1, wherein the pressure is a final pressure, and wherein the supplying the fluid comprises:
supplying the fluid at an initial pressure; and
increasing the pressure from the initial pressure to the final pressure over a particular time period.

4. The method of claim 1, wherein the supplying the fluid comprises supplying the fluid at a temperature of between about 10° C. and about 180° C.

5. The method of claim 1, wherein the supplying the fluid comprises supplying the fluid at a pulsed pressure over time.

6. The method of claim 1, wherein the supplying the fluid comprises supplying the fluid at a flow rate of greater than about 3 litres per minute.

7. The method of claim 1, wherein the period is less than 35 seconds.

8. The method of claim 1, further comprising at least one of:
measuring a weight or volume of the liquid removed from the fibre suspension, and when the weight or volume of the liquid has reached a predetermined amount, stopping the supply of fluid;
stopping the supply of fluid after a predetermined period of time;
measuring a volume of fluid supplied into the mould, and when the measured volume of fluid has reached a predetermined amount, stopping the supply of fluid;
measuring a temperature of the fluid, and when the measured temperature of the fluid has reached a predetermined temperature, stopping the supply of fluid; and
measuring a pressure reduction of the fluid and when the pressure reduction has reached a predetermined amount, stopping the supply of fluid.

9. The method of claim 8, wherein:
the fibre suspension has a first percentage liquid content by weight, L₁, when at least partially coating the mould cavity wall;
the moulded receptacle has a second percentage liquid content by weight, L₂; and
a percentage liquid content reduction, R, is greater than about 5%, where R=(L₁−L₂)/L₁.

10. The method of claim 1, further comprising applying a vacuum to the receptacle mould while applying the fibre suspension onto the mould cavity wall and while supplying the fluid.

11. The method of claim 1, further comprising applying a vacuum to the receptacle mould while applying the fibre suspension onto the mould cavity wall; and
ceasing to apply the vacuum before the supplying the fluid.

12. The method of claim 11, further comprising at least one of:
measuring a weight or volume of liquid extracted from the receptacle mould while applying the vacuum and when the weight or volume of liquid extracted from the receptacle mould has reached a predetermined amount, ceasing the applying the vacuum; and
ceasing the applying the vacuum after a predetermined period of time.

13. The method of claim 1, further comprising applying heat to the moulded receptacle to remove liquid from the moulded receptacle.

14. The method of claim 1, wherein the pressure is a particular pressure, and the method comprises determining the particular pressure on the basis of the receptacle type being moulded and/or one or more other criteria, and the supplying the fluid comprises supplying the fluid at the particular pressure.

15. A moulded receptacle produced by a method according to claim 1.

16. A system for forming a moulded receptacle, comprising:
a receptacle mould having a mould cavity wall, the mould cavity wall being configured to receive a coating of a fibre suspension thereon and having apertures formed therein;
a fibre suspension application system configured to apply the fibre suspension onto the mould cavity wall to at least partially coat the mould cavity wall; and
a fluid supply system configured to supply a fluid into direct contact with the fibre suspension on the mould cavity wall at a pressure of between about 3.5 bar and about 10 bar for a period of less than about 60 seconds, such that liquid is removed from the fibre suspension through the apertures to form the moulded receptacle on the mould cavity wall.

17. The system of claim 16, further comprising at least one of:
a liquid measurement system configured to measure a weight or volume of the liquid removed from the fibre suspension, wherein the fluid supply system is configured to stop the supply of the fluid when the liquid measurement system determines that the weight or volume of the liquid has reached a predetermined amount;
a timing system configured to measure a time during which the fluid supply system supplies the fluid, wherein the fluid supply system is configured to stop the supply of the fluid when the timing system determines that time has reached a predetermined period of time;
a fluid measurement system configured to measure a volume of fluid supplied by the fluid supply system, wherein the fluid supply system is configured to stop the supply of the fluid when the fluid measurement system determines that the volume of fluid has reached a predetermined amount;
a temperature measurement system configured to measure a temperature of the fluid, wherein the fluid supply system is configured to stop the supply of the fluid when the temperature measurement system determines that the temperature of the fluid has reached a predetermined temperature; and
a pressure measurement system configured to measure a pressure reduction of the fluid, wherein the fluid supply system is configured to stop the supply of the fluid when the pressure measurement system determines that the pressure reduction of the fluid has reached a predetermined amount.

18. The system of claim 16, further comprising:
a vacuum application system configured to:
apply a vacuum to the receptacle mould while the fibre suspension application system applies the fibre suspension onto the mould cavity wall; and
stop applying the vacuum before the fluid supply system supplies the fluid; and
at least one of:
a liquid measurement system configured to measure a weight or volume of the liquid removed from the receptacle mould while the vacuum is applied, wherein the vacuum application system is configured to stop applying the vacuum when the liquid measurement system determines that the weight or volume of the liquid has reached a predetermined amount; and
a timing system configured to measure a time during which the vacuum application system applies the vacuum, wherein the vacuum application system is configured to stop the application of the vacuum when the timing system determines that time has reached a predetermined period of time.

19. The system of claim 16, wherein the fluid supply system is configured to:
determine a particular pressure on the basis of the receptacle type being moulded and/or one or more other criteria; and
supply the fluid at the particular pressure.

20. The system of claim 16, wherein the receptacle mould comprises a mould cavity, of which the mould cavity wall is a wall, and an opening through which the fluid can escape from the cavity while the fluid supply system supplies the fluid.
